(19) United States
(12) Patent Application Publication
(10) Pub. No.: US 2023/0193840 A1
(43) Pub. Date: Jun. 22, 2023

(54) METHODS AND SYSTEMS FOR SHUT DOWN OF A MULTI-FUEL ENGINE

(71) Applicant: Transportation IP Holdings, LLC, Norwalk, CT (US)

(72) Inventors: Eric Dillen, Edinboro, PA (US); Adam Edgar Klingbeil, Ballston Lake, NY (US); Thomas Michael Lavertu, Ballston Lake, NY (US)

(21) Appl. No.: 17/645,710

(22) Filed: Dec. 22, 2021

(51) Int. Cl. F02D 19/06

(52) U.S. Cl. CPC F02D 19/0621; F02D 19/0644; F02D 19/0665; F02D 19/061; F02D 19/0605; F02D 19/0681; B61C 5/00

(57) ABSTRACT

Various methods and systems are provided for venting fuel lines in a dual-fuel engine. In one example, a method may include in response to an engine shut-down request, venting fuel lines to remove hydrogen from the fuel lines.

### BACKGROUND

### Technical Field

Embodiments of the subject matter disclosed herein relate to a multi-fuel engine system and more specifically, to a method to vent fuel lines in response to an engine shut down request.

### DISCUSSION OF ART

Vehicles, such as rail vehicles and other off-highway vehicles, may utilize a dual-fuel or multi-fuel engine system for propulsion. The dual-fuel engine system may allow vehicle navigation to be driven by torque produced through combustion of more than one type of fuel in an engine. In some examples, the more than one type of fuel may include hydrogen and diesel. Hydrogen may be delivered to the engine in a gaseous phase while diesel may be delivered in liquid phase. A substitution ratio of the fuel may be adjusted to adjust engine power output, emissions, engine temperature, and so forth. Combustion parameters may vary according to a ratio of hydrogen to diesel injected at the engine due to different physical properties of the fuels. For example, hydrogen may have a higher energy density, lower ignition energy, and wider range of flammability than diesel. As such, engine efficiency, power output, and emissions may be affected by co-combustion of hydrogen and diesel. It may be desirable to have system and method that differs from those that are currently available.

### BRIEF DESCRIPTION

In one embodiment, a method for an engine in a vehicle includes, in response to an engine shut-down request, venting fuel lines to remove hydrogen from the fuel lines.

The fuel lines may include a first fuel line portion joining a fuel reservoir housing hydrogen to a fuel modification unit, and a second fuel line portion joining the fuel modification unit to the engine. The engine shut-down request may be a short engine shut-down request with a subsequent engine start anticipated within a threshold duration of the shut-down request, or a long engine shut-down request with no subsequent engine start anticipated within the threshold duration. During a short engine shut-down request, flow of hydrogen from the fuel reservoir to the fuel modification unit may be suspended, and the second fuel line portion may be vented. During a long engine shut-down request, in addition to suspending flow of hydrogen from the fuel reservoir to the fuel modification unit, each of the first fuel line portion and the second fuel line portion may be vented, until the fuel lines are depressurized. The fuel lines may be vented by rotating the engine one or more times to draw in hydrogen from the second fuel line to the engine, and then routing diluted hydrogen to an exhaust stack. The second fuel line portion may also be vented by routing hydrogen from the second fuel line portion directly to the exhaust stack downstream of an exhaust turbine via a bypass passage.

### BRIEF DESCRIPTION OF THE DRAWINGS

FIG. 1 shows an example embodiment of a train including a rail vehicle consist.

FIG. 2. shows a schematic diagram of an example embodiment of a locomotive from FIG. 1 with a dual-fuel engine.

FIG. 3 shows an example embodiment of a fuel tender which may be include in the train of FIG. 1.

FIG. 4 shows a flow-chart illustrating an example routine for venting fuel lines during an engine shut-down.

FIG. 5 shows a flow-chart illustrating an example routine for purging the fuel lines during an engine shut-down.

### DETAILED DESCRIPTION

The following description relates to a system and methods for purging, venting, or both purging and venting fuel from fuel lines during shut down of an engine. As one example, when hydrogen is at least partially used to fuel the engine, hydrogen may occupy a first fuel line portion from the fuel reservoir to the regasification unit and a second fuel line portion from the regasification unit to the engine. During an engine shut down, it is desired to vent this hydrogen from the fuel lines, such that hydrogen may not leak out of the fuel system unexpectedly once the engine has been turned off. During a conditional stop, such as a short engine stop where an engine start is anticipated within a short duration, the hydrogen vapors in the fuel lines may be vented by spinning the engine one or more times following the engine-off command and flowing hydrogen and air through the engine with or without combustion. The second fuel line portion between the regasification unit and the engine may remain at higher than atmospheric pressure following this hydrogen vent to the engine. The diluted hydrogen may be released to the atmosphere. The release may be done in a location that can handle the hydrogen, such as for example via the exhaust stack. During a complete engine stop such as a longer engine stop wherein the immediately subsequent engine start is not anticipated within a short duration, the fuel lines may be vented by directly flowing hydrogen to exhaust stack bypassing the engine and/or via the engine while the engine is being spun one or more times following the engine-off command. The second fuel line portion may be depressurized by venting all the hydrogen contained therein. During certain conditions including a stop at a maintenance facility, the fuel lines may be purged of hydrogen by routing a pressurized inert gas through the fuel lines. The fuel lines may be vented prior to the purging.

The approach described herein may be employed in a variety of engine types, and a variety of engine-driven systems. Some of these systems may be stationary, while others may be on semi-mobile or mobile platforms. Semi-mobile platforms may be relocated between operational periods, such as mounted on flatbed trailers. Mobile platforms include self-propelled vehicles. Such vehicles can include on-road transportation vehicles, as well as mining equipment, marine vessels, rail vehicles, and other off-highway vehicles (OHV). For clarity of illustration, a locomotive is provided as an example of a mobile platform supporting a system incorporating an embodiment of the invention.

Embodiments of the invention are disclosed in the following description, and may relate to methods and systems for operating an internal combustion engine (ICE). The ICE may operate via a combination of different fuels as a mixture, and in different proportions relative to each other to form a substitution ratio of one fuel relative to another. These fuels may have relatively different amounts of carbon and suitable fuels may include one or more of gasoline, diesel, hydrogenation-derived renewable diesel (HDRD), alcohol(s), ethers, ammonia, biodiesels, hydrogen, natural gas, kerosene, syn-gas, and the like. The plurality of fuels may include gaseous fuels and liquid fuels, alone or in combination. The substitution ratio of a primary fuel of the ICE with a secondary fuel may be determined by a controller. The controller may determine the substitution ratio based at least in part on a current engine load. The controller may determine the substitution ratio based at least in part on the fuels used in the mixture, and their associated characteristics. The substitution ratio may be defined as a percentage of total fuel energy provided by the second fuel. In one embodiment, the substitution ratio may correspond to an injection amount of a fuel with a relatively lower carbon content or zero carbon content (e.g., hydrogen gas or ammonia). As the substitution ratio increases, the relative proportion of fuel with the lower or zero carbon content increases and the overall amount of carbon content in the combined fuel lowers.

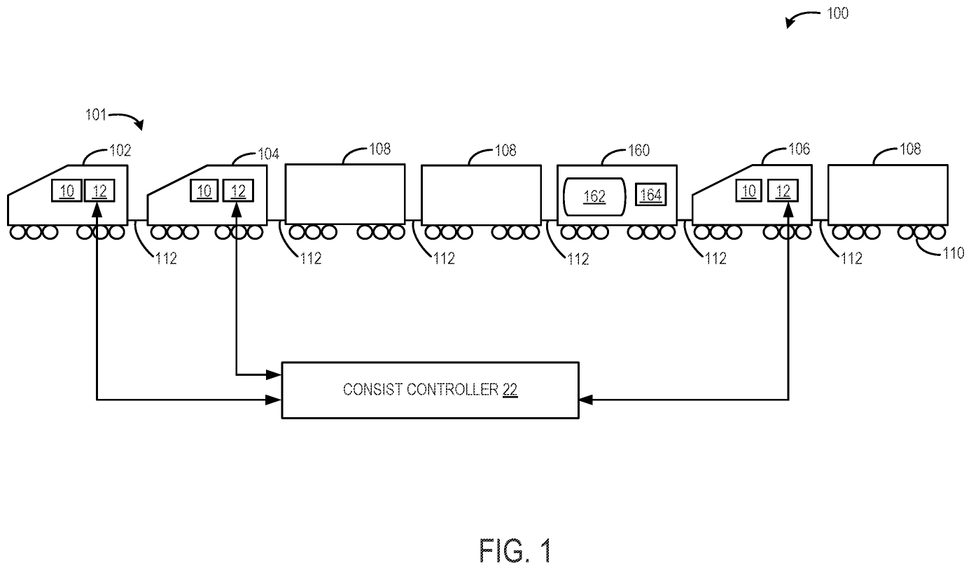

Before further discussion of the methods for venting and/or purging fuel lines in a multi-fuel or gas-burning engine, an example platform in which the methods may be implemented is shown. FIG. 1 depicts an example train 100, including a plurality of rail vehicles 102, 104, 106, a fuel tender 160, and cars 108, that can run on track 110. The plurality of rail vehicles, the fuel tender, and the cars are coupled to each other through couplers 112. In one example, the plurality of rail vehicles may be rail vehicles (locomotives), including a lead locomotive 102 and one or more remote locomotives 104, 106. Further, the locomotives in the train may form a consist. For example, in the embodiment depicted, the locomotives may form a consist 101. Various vehicles may form vehicle groups (such as consists, convoys, swarms, fleets, platoons, and the like). The vehicles in a group may be coupled together mechanically and/or virtually.

In some examples, the consist may include successive locomotives, e.g., where the locomotives are arranged sequentially without cars positioned in between. In other examples, as illustrated in FIG. 1, the locomotives may be separated by one or more cars in a configuration enabling distributed power operation. In this configuration, throttle and braking commands may be relayed from the lead locomotive to the remote locomotives by a radio link or physical cable, for example.

The locomotives may be powered by an engine 10, while the cars may be un-powered. In one example, the engine may be a multi-fuel engine. Where just two fuels are used, the multi-fuel engine may be referred to as a dual fuel engine. The engine may combust both hydrogen and diesel, and the combustion may be in varying ratios of the fuels relative to each other. Suitable fuels may be a gaseous fuel, a liquid fuel, or both, and the fuels may be hydrocarbon and/or non-hydrocarbon based. In other examples, the engine may be a single-fuel engine that can combust one of the gaseous or liquid fuels.

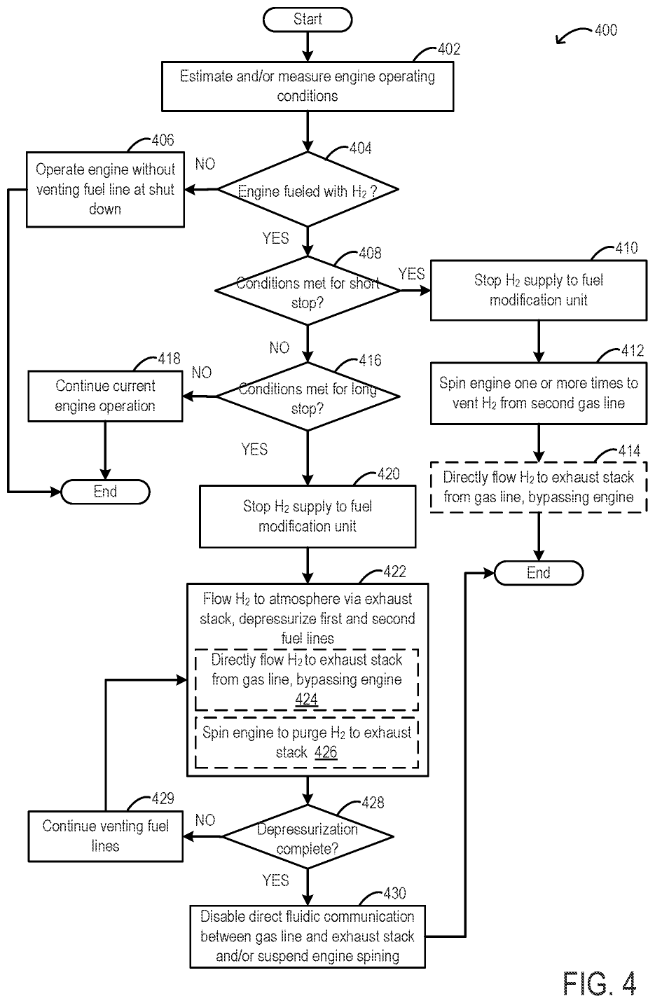

The train may further include a control system. The control system may include at least one engine controller 12 and it may include at least one consist controller 22. As depicted in FIG. 1, each locomotive includes an engine controller. The engine controller may be in communication with the consist controller. The consist controller may be located on one vehicle of the train, such as the lead locomotive, or may be remotely located, for example, at a dispatch center. The consist controller may receive information from, and transmit signals to, each of the locomotives of the consist. For example, the consist controller may receive signals from a variety of sensors on the train and adjust train operations accordingly. The consist controller is also coupled to each engine controller for adjusting engine operations of each locomotive. As elaborated with reference FIG. 4, upon receiving an engine shut-down request while the engine was being fueled at least partly with hydrogen, each engine controller may route hydrogen from fuel lines connecting a fuel reservoir storing the hydrogen fuel to the engine to the exhaust stack in order to vent the fuel lines.

The train may include at least one fuel tender, which may carry one or more fuel storage tanks 162 and includes a controller 164. While the fuel tender is positioned in front of the remote locomotive 106, other examples may include alternate locations of the fuel tender along the train. For example, the fuel tender may be instead positioned behind the remote locomotive or between the lead locomotive and the remote locomotive.

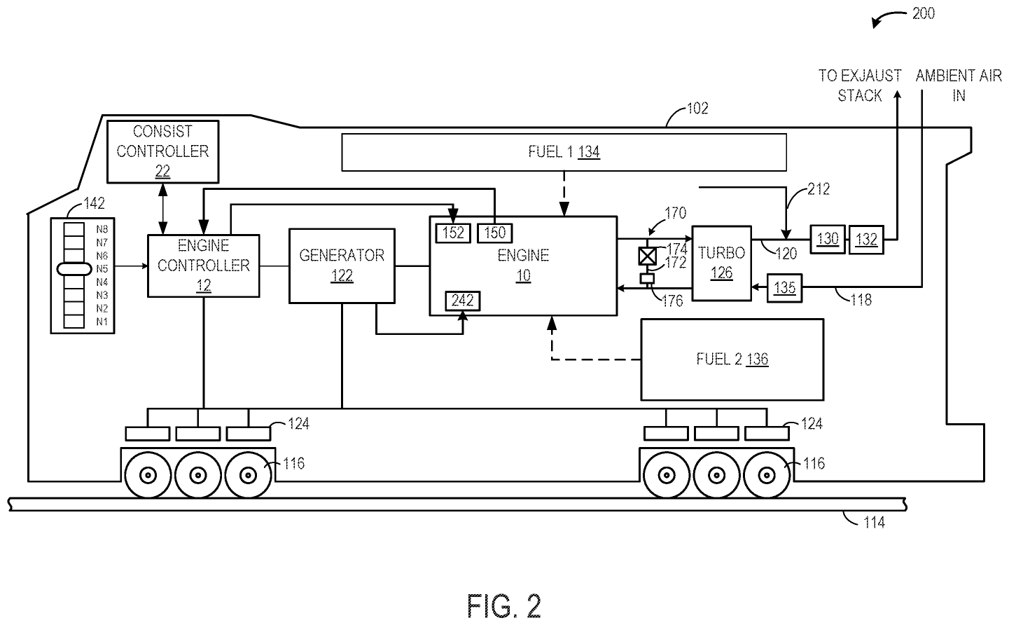

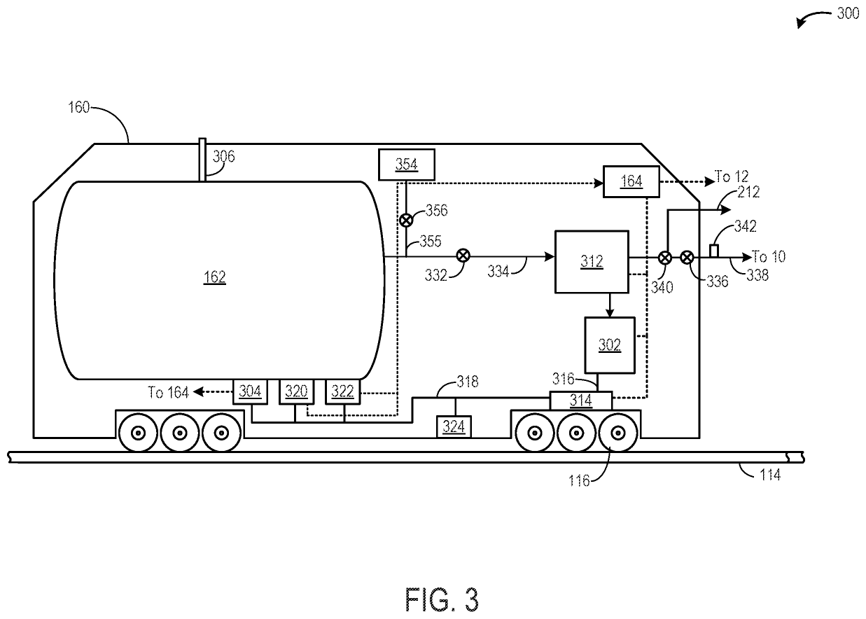

In one example, the fuel tender may be un-powered, e.g., without an engine or electric traction motors (e.g., electric traction motors 124 shown in FIG. 2). However, in other examples, the fuel tender may be powered for propulsion. For example, as shown in FIG. 3, the fuel tender may include an engine. The engine of the fuel tender may combust the fuel stored in the fuel storage tank and/or fuel stored at another vehicle of the train.

The one or more fuel storage tanks of the fuel tender may have a suitable structure for storing a specific type of fuel. In one example, the fuel storage tank may be adapted for cryogenic storage of liquefied natural gas (LNG). As another example, the fuel storage tank may be used to store a fuel in a liquid state at ambient temperature and pressure, such as diesel or ammonia. In yet another example, the fuel storage tank may store a fuel as a compressed gas, such as hydrogen or natural gas. In each instance, the fuel tender may be equipped with various mechanisms and devices for storage of the particular fuel. Further details of the fuel tender are shown further below, with reference to FIG. 3.

In some examples, fuel may be stored only at the fuel tender. In other examples, however, fuel may be stored both at the fuel tender and at one or more of the locomotives, e.g., as shown in FIG. 2. In addition, in some instances the fuel tender and/or the vehicle may have a fuel cell system. The fuel cell system may include a fuel cell, a fuel delivery system, an energy storage system, and one or more tanks of compressed fuel. Alternatively, the fuel may be stored on a vehicle to which the tender may be coupled.

FIG. 2 depicts an example embodiment of a locomotive as part of a train that can run on the track 110 via a plurality of wheels 116. Power for propulsion of the locomotive may be supplied at least in part by the engine. The engine receives intake air for combustion from an intake passage 118. The intake passage receives ambient air from an air filter (not shown) that filters air from outside of the locomotive. Exhaust gas resulting from combustion in the engine is supplied to an exhaust passage 120. Exhaust gas flows through the exhaust passage, and out of an exhaust stack (not shown) of the locomotive.

In one embodiment, the engine operates as a compression ignition engine. In another embodiment, the engine operates as a spark ignition engine. The engine may combust one specific fuel type only or may be able to combust two or more types of fuel, e.g., a multi-fuel engine. As such, the different fuel types may be combusted individually or co-combusted, e.g., combusted concurrently, at the engine. In one embodiment, the multi-fuel engine may be a dual-fuel engine, as depicted in FIG. 2, and the dual-fuel engine may receive a first fuel from a first fuel reservoir 134 and a second fuel from a second fuel reservoir 136.

While the locomotive is equipped with two fuel reservoirs in FIG. 2, in other examples, the locomotive may include only one fuel reservoir or no fuel reservoir. For example, at least one of the fuel reservoirs may be stored at the fuel tender, e.g., the fuel tender 160 of FIG. 1. Alternatively, a third fuel may be stored at the fuel tender in addition to the first fuel at the first fuel reservoir and the second fuel at the second fuel reservoir of the locomotive. In one example, fuels which may be stored at ambient pressure and temperature without additional equipment or specialized storage tank configurations, such as diesel, may be stored at the locomotive. Fuels demanding specialized equipment, such as for cryogenic or high pressure storage, may be stored on-board the fuel tender. In other examples, however, the locomotive and the fuel tender may each store fuels that do not demand specialized equipment.

The first, second, and third fuels (e.g., fuels stored on-board the train) may each be of different fuel types. Suitable fuels may include hydrocarbon-based fuels, such diesel, natural gas, methanol, ethanol, dimethyl ether (DME), etc. Other suitable fuels may be non-hydrocarbon-based fuels, such as hydrogen, ammonia, etc.

Additionally, each of the stored fuels may be a gaseous or a liquid phase fuel. Thus, when configured as a compression ignition engine combusting a single fuel type, the engine may consume a gaseous fuel or a liquid fuel. When the compression ignition engine is a multi-fuel engine, the engine may combust only liquid fuels, only gaseous fuels, or a combination of liquid and gaseous fuels. Similarly, when configured as a spark ignition engine combusting a single fuel type, the engine may also consume either a gaseous fuel or a liquid fuel. When configured as a multi-fuel spark ignition engine, the engine may combust only liquid fuels, only gaseous fuels, or a combination of liquid and gaseous fuels.

As either of the spark ignition or the compression ignition multi-fuel engine configurations, the engine may combust fuel combinations in different manners. For example, one fuel type may be a primary combustion fuel and another fuel type may be a secondary, additive fuel used under certain conditions to adjust combustion characteristics. For example, during engine startup, a fuel combustion mixture may include a smaller proportion of diesel to seed ignition while hydrogen may form a larger proportion of the mixture. In other examples, one fuel may be used for pilot injection prior to injection of the primary combustion fuel.

The engine, as the multi-fuel engine, may combust various combinations of the fuels and the fuels may be premixed or not premixed prior to combustion. In one example, the first fuel may be hydrogen and the second fuel may be diesel. In another example, the first fuel may be ammonia and the second fuel may be diesel. In yet another example, the first fuel may be ammonia and the second fuel may be ethanol. Further combinations are possible with storage of the third fuel on the fuel tender. For example, LNG may be stored at the fuel tender and the engine may combust LNG and hydrogen, or LNG, diesel, and hydrogen, or LNG, ammonia, and hydrogen. As such, numerous combinations of fuel types are possible, where the combinations may be determined based on compatibility of the fuels. A method of delivery of the fuels to the engine for combustion may similarly depend on properties of the fuel type.

When the engine is the single fuel-combusting engine (either spark ignition or compression ignition), the engine may consume a single liquid phase fuel. For example, the engine may combust diesel, hydrogen, ammonia, LNG, or another liquid phase fuel. Similarly, the engine may combust a single gaseous fuel, such as hydrogen, or another gaseous fuel.

A fuel that is stored on-board in one physical state, e.g., gas or liquid, may be delivered to the engine in the same state or a different state. For example, LNG may be stored cryogenically in the liquid phase but may undergo a transition to the gas phase, e.g., at a regasification unit in the fuel tender, prior to injection at the engine. Other fuels, however, may be stored as a liquid and injected as a liquid or stored as a gas and injected as a gas.

Fuels may be injected at the engine according to more than one injection technique, for example. In one example, one or more of the fuels may be delivered to the engine cylinders via an indirect injection method, such as port injection. In another example, at least one of the fuels may be introduced to the engine cylinders via direct injection. In yet another example, at least one of the fuels may be injected by central manifold injection. The engine may receive the fuels exclusively by indirect injection, exclusively by direct injection, or by a combination of indirect and direct injection. As one example, the fuels may be injected via port injection during low loads and by direct injection during high loads. In particular, when one of the fuels is a gaseous fuel, premixing of the gaseous fuel may be desirable via port injection. The fuels may also be premixed when introduced by central manifold injection. Premixing by direct injection is also possible, such as by injection of the gaseous fuel during an intake stroke of the engine cylinders.

Each type of injection may include injection of either gaseous or liquid phase fuels. However, some injection methods may be more suitable for certain fuels depending on specific properties of the fuel type. For example, hydrogen may be injected by port injection or direct injection. Liquid phase fuels, such as diesel, may be injected by direct injection. Ammonia and natural gas may each be selectively injected by port injection or direct injection. Similarly, fuels such as methanol and ethanol may be either port injected or direct injected. In some instances, the engine may have fuel injectors capable of switching between injection of gaseous fuels and of liquid fuels.

The fuels combusted by the dual-fuel engine, whether in the gas phase or liquid phase, may or may not be premixed prior to combustion according to the type of fuel. For example, depending on operating conditions, premixing of hydrogen, natural gas, ammonia, methanol, ethanol, and DME may be desirable. During other operating conditions, fuels such as diesel, hydrogen, natural gas, methanol, and ethanol may not be premixed. Premixing of the fuels may include port injection of at least one of the fuels into an inlet manifold or inlet port where the fuel may mix with air before entering a cylinder. As another example, each of the fuels may be port injected, allowing the fuels to mix with one another and with air prior to combustion. In other examples, the fuel(s) may be injected into a pre-combustion chamber fluidically coupled to a cylinder head where the fuel(s) may mix with air in the pre-combustion chamber before flowing to the cylinder head.

Alternatively, as described above, the fuels may be delivered to the engine cylinders by directly injecting one or more fuels into the engine cylinders when the cylinders are filled with at least the compressed air and, in some instances, the gas phase fuel. Direct injection may include injecting late in the compression stroke or during the expansion stroke when the cylinder is near TDC, typically referred to as high pressure direct injection (HPDI) and injection during the intake stroke or early in the compression stroke, typically referred to as low pressure direct injection (LPDI). When direct injected, the fuels may not be premixed, in one example. However, in another example, premixing may be enabled by direct injection of one or more of the fuels prior to a compression stroke of the engine cylinders, as described above.

Furthermore, a type of gaseous fuel used may determine whether direct injection of the fuel may include HPDI or LPDI, or both HPDI and LPDI. For example, hydrogen, when stored as a compressed gas, may be injected by HPDI or by LPDI, depending on engine load and available delivery pressure. In particular, HPDI of hydrogen may alleviate knock due to continuous burning of the hydrogen as the hydrogen mixes in the engine cylinders. Furthermore, HPDI may enable greater substitution rates of hydrogen, e.g., substituting for diesel, for example, thereby decreasing hydrocarbon, NOx, and particulate matter emissions during engine operation.

An injection ratio of the fuels for co-combustion may vary according to operating conditions. For example, when the first fuel is hydrogen and the second fuel is diesel, a hydrogen-diesel ratio may be decreased in response to an increase in power demand at the engine. The adjusting of the ratio of diesel to hydrogen may be further based on a geographical location of the vehicle, and the fraction of the hydrogen injected may be increased in response to the geographical location of the vehicle being a green state.

As shown in FIG. 2, the engine is coupled to an electric power generation system, which includes an alternator/generator 122 and the electric traction motors. For example, the engine generates a torque output that is transmitted to the alternator/generator which is mechanically coupled to the engine. The alternator/generator produces electrical power that may be stored and applied for subsequent propagation to a variety of downstream electrical components. As an example, the alternator/generator may be electrically coupled to the electric traction motors and the alternator/generator may provide electrical power to the electric traction motors. As depicted, the electric traction motors are each connected to one of a plurality of wheels 116 to provide tractive power to propel the locomotive. One example locomotive configuration includes one traction motor per pair of wheels. As depicted herein, six pairs of traction motors correspond to each of six pairs of wheels of the locomotive.

The locomotive may further include one or more turbochargers 126 arranged between the intake passage and the exhaust passage. The turbocharger increases air charge of ambient air drawn into the intake passage in order to provide greater charge density during combustion to increase power output and/or engine-operating efficiency. The turbocharger may include a compressor (not shown) which is at least partially driven by a turbine (not shown). While in this case a single turbocharger is included, the system may include multiple turbine and/or compressor stages. Further, in some embodiments, a wastegate may be provided which allows exhaust gas to bypass the turbocharger. The wastegate may be opened, for example, to divert the exhaust gas flow away from the turbine. In this manner, the rotating speed of the compressor, and thus the boost provided by the turbocharger to the engine may be regulated. In addition, an electric compressor 135 (also referred as electric booster) may be coupled to the intake passage or a bypass line parallel to the intake passage upstream or downstream of the turbocharger compressor. The electric compressor may be operated via an electric motor powered by a battery.

The locomotive may include an exhaust gas recirculation (EGR) system 170. The EGR system may route exhaust gas from the exhaust passage upstream of the turbocharger to the intake passage downstream of the turbocharger. The EGR system includes an EGR passage 172 and an EGR valve 174 for controlling an amount of exhaust gas that is recirculated from the exhaust passage of the engine to the intake passage of the engine. By introducing exhaust gas to the engine, the amount of available oxygen for combustion is decreased, thereby reducing the combustion flame temperatures and reducing the formation of nitrogen oxides (e.g., NOx). The EGR valve may be an on/off valve controlled by the locomotive controller, or it may control a variable amount of EGR, for example.

The EGR system may further include an EGR cooler 176 to reduce the temperature of the exhaust gas before it enters the intake passage. As depicted in the non-limiting example embodiment of FIG. 2, the EGR system is a high-pressure EGR system. In other embodiments, the locomotive may additionally or alternatively include a low-pressure EGR system, routing EGR from a location downstream of the turbocharger to a location upstream of the turbocharger. As an example, as elaborated with relation to FIG. 4, the EGR system may be a donor cylinder EGR system where one or more cylinders provide exhaust gas only to the EGR passage, and then to the intake.

The locomotive may include an exhaust gas treatment system coupled in the exhaust passage to reduce regulated emissions. In one example embodiment, the exhaust gas treatment system may include a diesel oxidation catalyst (DOC) 130 and a diesel particulate filter (DPF) 132. The DOC may oxidize exhaust gas components, thereby decreasing carbon monoxide, hydrocarbons, and particulate matter emissions. The DPF is configured to trap particulates, also known as particulate matter (an example of which is soot), produced during combustion, and may be comprised of ceramic, silicon carbide, or any suitable material. In other embodiments, the exhaust gas treatment system may additionally include a selective catalytic reduction (SCR) catalyst, three-way catalyst, NOₓ, trap, various other emission control devices or combinations thereof. In some embodiments, the exhaust gas treatment system may be positioned upstream of the turbocharger, while in other embodiments, the exhaust gas treatment system may be positioned downstream of the turbocharger. After treatment at the exhaust gas treatment system, the exhaust gas may be routed to an exhaust stack at the top of the rail vehicle.

A bypass line 212 may connect a fuel line to the exhaust passage downstream of the turbocharger and upstream of the exhaust gas treatment system. A first end of the bypass line may be connected to a three-way valve housed in a fuel line connecting the fuel modification unit to the engine. Details of the bypass line is described with relation to FIG. 3.

The locomotive may further include a throttle 142 coupled to the engine to indicate power levels. In this embodiment, the throttle is depicted as a notch throttle. However, any suitable throttle is within the scope of this disclosure. Each notch of the notch throttle may correspond to a discrete power level. The power level indicates an amount of load, or engine output, placed on the locomotive and controls the speed at which the locomotive will travel. Although eight notch settings are depicted in the example embodiment of FIG. 2, in other embodiments, the throttle notch may have more than eight notches or less than eight notches, as well as notches for idle and dynamic brake modes. In some embodiments, the notch setting may be selected by a human operator of the locomotive. In other embodiments, the consist controller may determine a trip plan (e.g., a trip plan may be generated using trip optimization software, such as Trip Optimizer system available from Wabtec Corporation and/or a load distribution plan may be generated using consist optimization software such as Consist Manager available from Wabtec Corporation) including notch settings based on engine and/or locomotive operating conditions, as will be explained in more detail below.

The engine controller may control various components related to the locomotive. As an example, various components of the locomotive may be coupled to the engine controller via a communication channel or data bus. In one example, the engine controller and the consist controller each include a computer control system. The engine controller and consist controller may additionally or alternatively include a memory holding non-transitory computer readable storage media (not shown) including code for enabling on-board monitoring and control of locomotive operation. The engine controller may be coupled to the consist controller, for example, via a digital communication channel or data bus.

Both the engine controller and the consist controller may receive information from a plurality of sensors and may send control signals to a plurality of actuators. The engine controller, while overseeing control and management of the locomotive, may receive signals from a variety of engine sensors 150, as further elaborated herein, in order to determine operating parameters and operating conditions, and correspondingly adjust various engine actuators 152 to control operation of the locomotive. For example, the engine controller may receive signals from various engine sensors including, but not limited to, engine speed, engine load, intake manifold air pressure, boost pressure, exhaust pressure, ambient pressure, ambient temperature, exhaust temperature, engine temperature, exhaust oxygen levels, etc. Correspondingly, the engine controller may control the locomotive by sending commands to various components such as the electric traction motors, the alternator/generator, cylinder valves, fuel injectors, the notch throttle, etc. Other actuators may be coupled to various locations in the locomotive.

The consist controller may include a communication portion operably coupled to a control signal portion. The communication portion may receive signals from locomotive sensors including locomotive position sensors (e.g., GPS device), environmental condition sensors (e.g., for sensing altitude, ambient humidity, temperature, and/or barometric pressure, or the like), locomotive coupler force sensors, track grade sensors, locomotive notch sensors, brake position sensors, etc. Various other sensors may be coupled to various locations in the locomotive. The control signal portion may generate control signals to trigger various locomotive actuators. Example locomotive actuators may include air brakes, brake air compressor, traction motors, etc. Other actuators may be coupled to various locations in the locomotive. The consist controller may receive inputs from the various locomotive sensors, process the data, and trigger the locomotive actuators in response to the processed input data based on instruction or code programmed therein corresponding to one or more routines. Further, the consist controller may receive engine data (as determined by the various engine sensors, such as an engine coolant temperature sensor) from the engine controller, process the engine data, determine engine actuator settings, and transfer (e.g., download) instructions or code for triggering the engine actuators based on routines performed by the consist controller back to the engine controller.

For example, the consist controller may determine a trip plan to distribute load amongst all locomotives in the train, based on operating conditions. In some conditions, the consist controller may distribute the load unequally, that is, some locomotives may be operated at a higher power setting, or higher notch throttle setting, than other locomotives. The load distribution may be based on a plurality of factors, such as fuel economy, coupling forces, tunneling operating, grade, etc. In one example, the load distribution may be adapted based on a distribution of the locomotive consist, e.g., a positioning of each of the locomotives of the locomotive consist, across the train. For example, at least one locomotive may be positioned at an end of the train and at least one locomotive may be positioned at a front of the train. The locomotive at the end of the train may push propulsion of the train and the locomotive at the front of the train may pull the train, particularly during uphill navigation. As such, a greater load may be placed on the pushing locomotive at the end of the train.

Turning now to FIG. 3, an embodiment of the fuel tender 160 of FIG. 1 is shown. As described above, the fuel tender includes the fuel storage tank (also referred herein as reservoir) 162, the controller 164, and the engine 302. The fuel tender may further include a first unit 304, which may be a device for controlling a temperature and pressure within the fuel storage tank. For example, when LNG is stored in the fuel storage tank, the first unit may be a cryogenic unit. The fuel storage tank sizes and configurations may be selected based on end use parameters, may be removable from the fuel tender, and may receive fuel from an external refueling station via port 306.

The fuel storage tank may supply liquid fuel to a fuel modification unit (also referred herein as a vaporizer unit) 312 via a first fuel line portion 334. A first valve 332 may regulate flow of fuel from the fuel storage tank to the fuel modification unit. The first fuel line portion 334 may include a pressure sensor to monitor pressure in the first fuel line portion 334. A tank 354 storing a purge fluid may be fluidly connected to the first fuel line portion 334 via a purge line 355. The purge fluid may be one of an inert gas (such as helium, argon), exhaust gas, oxygen, etc. The tank may store the purge fluid at a pressure higher than atmospheric pressure. Flow of the purge fluid through the fuel line may be regulated via a purge valve 356 housed in the purge line 355.

The fuel modification unit may be configured to adjust a characteristic of the fuel. For example, the fuel may be converted from a liquid phase to a gas phase at the fuel modification unit, such as when the fuel is LNG or hydrogen. As another example, the fuel modification unit may be a pump to adjust a delivery pressure of the fuel when the fuel is stored in the gas phase. In other examples, where fuel modification is not demanded, the fuel modification unit may be omitted. The fuel may be delivered from the fuel modification unit to engines of the locomotives. From the fuel modification unit, the gaseous fuel may be supplied to the engine via a second fuel line portion 338. During engine operation, the second fuel line portion 338 may be maintained at a higher than atmospheric pressure. A pressure sensor 342 may be coupled to the second fuel line portion to estimate the pressure of the second fuel line portion. A second valve 336 may be housed in the second fuel line portion 338 to regulate fuel flow from the fuel modification unit to the engine. In the open position of the second valve, the fuel from the fuel modification unit may be directly routed to the engine. A bypass valve 340 may be housed in the second fuel line portion upstream or downstream of the second valve to route residual fuel from the second fuel line portion directly to the exhaust stack via the bypass passage. A hydrogen sensor may be positioned in the first fuel line portion 334 and/or the second fuel line portion 338 to estimate a hydrogen concentration in the fuel line.

In response to a short engine shut-down request, flow of hydrogen from the fuel reservoir to the vaporizer unit may be suspended by closing the first valve 332, and the second fuel line 338 may be vented without depressurizing the first fuel line portion. Venting of the second fuel line portion may take place while the engine is spinning down from being shut down (such as due to momentum) or may include rotating the engine one or more times via a motor. The second valve 336 may be closed and injection of hydrogen to the engine cylinders may be continued to draw in hydrogen from the second fuel line portion to the engine. In an alternate embodiment, the second valve 336 may be located on the locomotive and the closing of the valve to vent the fuel line may be at the locomotive. Then the diluted hydrogen may be routed to the exhaust stack. The rotation of the engine one or more times may be via operation of a starter motor powered from an on-board battery. Alternatively, the engine may continue to rotate under its own momentum, or it may continue to idle a period of time while the fuel is vented. Also, during the rotation of the engine one or more times, an electric intake compressor may be rotated, such as via the electric motor, to route compressed air through the engine to dilute the hydrogen flowing through the engine. In response to a long engine shut-down request, flow of hydrogen from the fuel reservoir to the vaporizer unit may be suspended by closing the first valve, and each of the first fuel line portion and the second fuel line portion may be vented until both fuel lines are depressurized. Venting the second line may also be carried out by routing hydrogen from both fuel lines directly to the exhaust stack downstream of the exhaust turbine via the bypass valve and the bypass passage, bypassing the engine. In one example, the vented hydrogen gas may be captured in a tank and released at a later time or pressurized and used as a purge fluid. In a short engine shut-down request, a subsequent engine start may be anticipated within a threshold duration of the shut-down request, and in a long engine shut-down request, no subsequent engine start may be anticipated within the threshold duration. A method to vent the fuel lines in response to an engine shut-down request is elaborated in FIG. 4.

During a maintenance stop of the vehicle or upon a concentration of hydrogen in the fuel line increasing to above a first threshold concentration during an engine stop, the first fuel line portion and the second fuel line portion may be purged until hydrogen is removed both fuel line portions. The pressurized purge fluid from the tank 354 may be routed to the fuel line via the purge valve 356 and the purge line 355. The fuel line may be purged until the hydrogen concentration in the fuel line decreases to below a second hydrogen concentration.

In one example, the liquid or gaseous hydrogen may not be contained in a tank or reservoir but the hydrogen may be harvested from a solid structure. Such systems may have a slower response time to changes in operating conditions including temperature and pressure. Upon suspension of use of hydrogen from such a system, the fluid lines joining the solid structure to the engine, may be vented of hydrogen by rotating the engine and routing the hydrogen to the exhaust stack, as described above.

By supplying fuel from the fuel storage tank to the locomotive engines and the engine of the fuel tender, the fuel may be combusted by the engines distributed across the train. In another non-limiting embodiment, the fuel tender engine may generate electricity that may be delivered to one or more components on-board the fuel tender and/or on-board the locomotives. In one example, as depicted in FIG. 3, the fuel tender engine may generate torque that is transmitted to a power conversion unit 314 via drive shaft 316. The power conversion unit converts the torque into electrical energy that is delivered via electrical bus 318 to a variety of downstream electrical components in the fuel tender. Such components may include, but are not limited to, the first unit, the fuel modification unit, the controller, a pressure sensor 320, a temperature sensor 322, batteries 324, various valves, flow meters, additional temperature and pressure sensors, compressors, blowers, radiators, batteries, lights, on-board monitoring systems, displays, climate controls, and the like, some of which are not illustrated in FIG. 3 for brevity. Additionally, electrical energy from the electrical bus may be provided to one or more components of the locomotives.

In one example the power conversion unit includes an alternator (not shown) that is connected in series to one or more rectifiers (not shown) that convert the alternator's AC electrical output to DC electrical power prior to transmission along the electrical bus. Based on the configuration of a downstream electrical component receiving power from the electrical bus, one or more inverters may invert the electrical power from the electrical bus prior to supplying electrical power to the downstream component. In one example, a single inverter may supply AC electrical power from a DC electrical bus to a plurality of components. In another non-limiting embodiment, each of a plurality of distinct inverters may supply electrical power to a distinct component.

The controller on-board the fuel tender may control various components on-board the fuel tender, such as the fuel modification unit, the fuel tender engine, the power conversion unit, the first unit, control valves, and/or other components on-board the fuel tender, by sending commands to such components. The controller may also monitor fuel tender operating parameters in active operation, idle and shutdown states. Such parameters may include, but are not limited to, the pressure and temperature of the fuel storage tank, a pressure and temperature of the fuel modification unit, the fuel tender engine temperature, pressure, and load, compressor pressure, heating fluid temperature and pressure, ambient air temperature, and the like. In one example, the fuel tender controller may execute code to auto-stop, auto-start, operate and/or tune the engine and the fuel modification unit in response to one or more control system routines. The computer readable storage media may also execute code to transmit to and receive communications from the engine controllers on-board the locomotives.

The fuel tender depicted in FIG. 3 is a non-limiting example of how the fuel tender may be configured. In other examples, the fuel tender may include additional or alternative components. As an example, the fuel tender may further include one or more additional sensors, flow meters, control valves, various other device and mechanisms for controlling fuel delivery and storage conditions, etc.

In this way, the components described in FIGS. 1-3 enable a controller storing instructions in non-transitory memory that, when executed, cause the controller to: in response to a request to suspend fueling engine cylinders with hydrogen, rotate the engine one or more times, unfueled, to route hydrogen from a fuel line to an exhaust stack.

FIG. 4 depicts a flow chart for a routine 400 for venting fuel lines in response to an engine shut-down request in a vehicle (such as rail vehicle 102 in FIG. 2). The routine may be carried out by the controller of the engine shown in FIG. 2, for example.

At step 402, engine operating conditions may be estimated and/or measured. As an example, the engine operating conditions to be estimated and/or measured may include engine speed, engine temperature, engine load, torque demand, boost demand, engine dilution demand, and so on. The geographical location of the vehicle may also be obtained from an on-board navigational system. In one example, the controller on-board the vehicle may include a navigation system (e.g., global positioning system, GPS) via which a location of the vehicle (e.g., GPS co-ordinates of the vehicle) may be retrieved. In another example, the location of the vehicle may be retrieved form an external network communicatively coupled to the vehicle.

At 404, the routine includes determining if the engine is at least partially being fueled with hydrogen. Hydrogen may burn effectively at lean conditions and may not produce carbon dioxide as the product of combustion, thereby reducing emission of greenhouse gases. In one example, a mixture of hydrogen and diesel may be injected to each cylinder. By including diesel, auto ignition of the fuel mixture may be attained. In another example, natural gas may be used along with hydrogen and the mixture may be spark ignited in the cylinder. The two fuels may be pre-mixed and then delivered to each cylinder or the fuels may be separately, directly injected to the cylinder. As an example, hydrogen and natural gas may be port injected, while diesel may be direct injected near top dead center (TDC) to initiate combustion. Hydrogen and natural gas may also be direct injected.

If it is determined that engine operation is carried out without hydrogen being injected, at 406, current engine operation may be continued, and in response to an engine shut-down request, the engine may be shut-down without venting fuel lines of hydrogen. If it is determined that the engine is at least partially fueled with hydrogen, at 408, the routine includes determining if the conditions are met for a short stop of the engine. An engine stop request may be received based on a reduction in torque demand and application of a brake. A short stop of the engine may be an engine stop following which an immediately subsequent engine restart is anticipated within a threshold duration. The threshold duration may be based on engine operating conditions such as engine speed and engine temperature at engine shut-down. As an example, the threshold duration may be in the range of 10-20 minutes. As an example, the controller may determine the engine stop to be a short stop based on the geographical location of the vehicle. In one example, the vehicle may make a short stop at a railway station, and the subsequent start time may be known. In another example, the vehicle may be sitting on a siding and an Auto Engine Start Stop (AESS) logic may command the engine off to conserve fuel enabling a short engine stop. In yet another example, the operator may command either a short or long shutdown through a human-machine interface (HMI).

If it is determined that conditions are met for an engine short-stop, the routine may proceed to step 410. As an example, even in absence of an engine-off request, if a suspension of hydrogen injection is requested (wherein fueling may be continued using other fuels such as diesel, natural gas, etc.), the routine may proceed to step 410.

At step 410, supply of hydrogen from the fuel reservoir to the fuel modification unit may be suspended, such as by actuating each of the first valve (such as valve 332 in FIG. 3) housed in the first fuel line portion connecting the fuel reservoir to the fuel modification unit and the second fuel valve (such as valve 336 in FIG. 3) to a closed position. Injection of hydrogen to the engine cylinders may be continued until a pressure in the second fuel line portion (such as estimated via pressure sensor 342 in FIG. 3) reduces to atmospheric pressure.

At 412, the engine may be spun one or more times with fuel injection to vent any hydrogen from the second gas line. In one example, the spinning of the engine may only be carried out if the pressure in the second fuel line portion remains above atmospheric pressure. During this venting process, the first gas line may be maintained at a higher than atmospheric pressure. The engine may be rotated a threshold number of times to vent the hydrogen from the fuel lines. The threshold number of times may be directly proportional to the predicted amount of hydrogen remaining in the fuel line after the engine shut-down request. The amount of hydrogen remaining in the fuel line after the engine shut-down request may be predicted as a function of the amount of hydrogen being injected prior to the engine shut-down request. The engine may spin due to its angular momentum after it is commanded off or may be spun via a starter motor powered by an on-board battery.

During spinning the engine, the intake throttle (SI engine) may be opened to draw in ambient air. Also, if available, an intake electric compressor may be operated to flow compressed air through the engine. As the engine is spun, hydrogen from the fuel lines may be drawn into the engine. In one example, the hydrogen may be combusted, such as with spark. In another example, the hydrogen diluted with ambient air (which may also include compressed air) may flow through the engine and enter the exhaust passage uncombusted. The diluted hydrogen may then flow out through the exhaust stack. In this way, hydrogen from the second fuel line portion may be vented out of the engine system through the engine and the exhaust stack.

In addition to or alternate to routing the hydrogen through the engine, at step 414, hydrogen from the second fuel line portion may be directly routed to the exhaust stack via the bypass line connecting the second fuel line portion to the exhaust line downstream of the exhaust turbine. The controller may send a signal to the bypass valve housed in the second fuel line portion to open, thereby routing at least a part of the hydrogen within the second fuel line portion directly to the exhaust stack downstream of the turbine via the bypass passage. As the hydrogen flows out, the second fuel line portion may be vented. During a short engine stop, this routing of hydrogen may be carried out for a threshold duration without depressurizing the second fuel line portion. The duration of hydrogen venting may be directly proportional to the predicted amount of hydrogen remaining in the fuel line after the engine shut-down request.

If it is determined that conditions are not met for an engine short-stop, at 416, the routine includes determining if conditions are met for an engine long-stop. As described previously, an engine stop request may be received based on a reduction in torque demand and an application of a brake. A long stop of the engine may be an engine stop following which an immediately subsequent engine restart is not anticipated within the threshold duration. In other words, upon a long engine stop, the engine is anticipated to stay inactive for longer than the threshold duration. The threshold duration may be based on engine operating conditions, such as engine speed and engine temperature at engine shut-down. As an example, the threshold duration may be in the range of 10-20 minutes. As an example, the controller may determine the engine stop to be a long stop based on the geographical location of the vehicle. In one example, if the vehicle is located at a railway yard, it may be determined that the vehicle may rest for a longer than threshold duration. Alternatively, a long stop may be commanded by an operator through an HMI. As an example, the operator may indicate a stop to be a long stop via a button or by sending a command to the controller via the HMI.

If it is determined that conditions are not met for the long stop, it may be inferred that an engine shut-down request has not been made and at step 418, current engine operation may be carried out. The engine may be continued to be fueled with hydrogen.

If it is determined that conditions are met for the long engine stop, at step 420, supply of hydrogen from the fuel reservoir to the fuel modification unit may be suspended. The first valve housed in the first fuel line portion connecting the fuel reservoir to the fuel modification unit may be actuated to a closed position to suspend the hydrogen flow to the fuel modification unit. Injection of hydrogen to the engine cylinders may be continued to remove hydrogen from the fuel lines.

At step 422 hydrogen from each of the first fuel line portion and the second fuel line portion may be routed to the exhaust stack and depressurized in the process. Depressurization includes, reducing a pressure in each of the first fuel line portion and the second fuel line portion to atmospheric pressure. Routing hydrogen to atmosphere includes, at step 422, directly flowing hydrogen from the second fuel line portion to the exhaust stack via the bypass line connecting the second fuel line portion to the exhaust line downstream of the exhaust turbine. The bypass valve housed in the second fuel line portion may be actuated to an open position to establish fluidic communication between the second fuel line portion and the exhaust stack via the bypass passage. Hydrogen from the first fuel line portion may also flow into the second fuel line portion and be routed to the exhaust stack.

Routing hydrogen to atmosphere further includes, at step 426, spinning the engine with or without injecting fuel (hydrogen) to vent any hydrogen from each of the first gas line and the second gas line. The engine may be spun via the starter motor powered by an on-board battery. During spinning the engine, the intake throttle may be opened to draw in ambient air. Also, the intake electric compressor may be operated to flow compressed air through the engine. As the engine is spun, hydrogen from the fuel lines may be drawn into the engine. In one example, the hydrogen flowing through the engine may be combusted such as with spark or ignition from a diesel pilot injection. In another example, the hydrogen diluted with ambient air may flow through the engine and enter the exhaust passage uncombusted. The diluted hydrogen may then flow out through the exhaust stack. In this way, hydrogen from the fuel lines may be vented out of the engine system through the engine and the exhaust stack. The steps 424 and 426 may both be carried out to vent the fuel lines or either one of them may be carried out.

At 428, the routine includes determining, if depressurization of each of the first the second fuel line portion is complete. Depressurization of the fuel lines may be confirmed based on the pressure sensor housed in the fuel lines recording an atmospheric pressure. If it is determined that depressurization is incomplete and either of the fuel line is at a higher than atmospheric pressure, at 429, the fuel lines may be continued to be vented by flowing hydrogen to the exhaust stack.

If it is determined that depressurization is complete and the pressure in the second fuel line portion has reduced to atmospheric pressure, it may be inferred that venting of the fuel lines in response to a long engine shut down request has been completed. At 430, if hydrogen was routed to the exhaust stack via the bypass valve and the bypass passage, the direct fluidic communication between the second gas line and the exhaust stack may be disabled by actuating the bypass valve to a closed position. Additionally or alternately, if the engine was being spun, via the starter motor, to draw out the hydrogen from the fuel lines to the engine, the starter motor may be disabled to suspend further engine spinning.

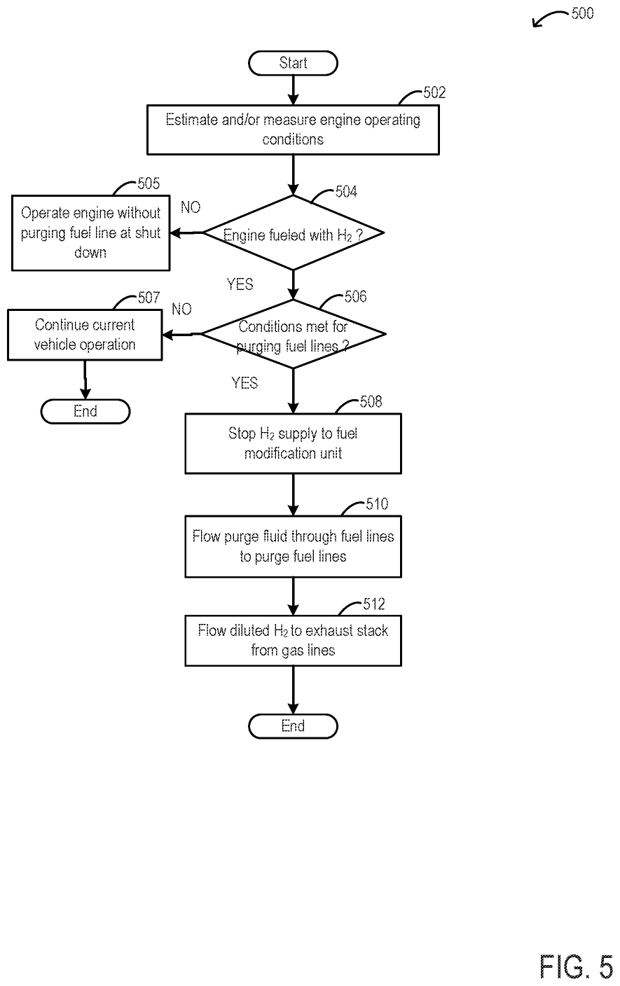

FIG. 5 depicts a flow chart for a routine 500 for purging fuel lines in response to an engine shut-down request in a vehicle (such as rail vehicle 102 in FIG. 2). In one example, the purging of the fuel lines may follow a venting of the fuel line via the method 400 as discussed in FIG. 4. The routine may be carried out by the controller of the engine shown in FIG. 2, for example.

At step 502, engine operating conditions may be estimated and/or measured. As an example, the engine operating conditions to be estimated and/or measured may include engine speed, engine temperature, engine load, torque demand, boost demand, engine dilution demand, and so on. The geographical location of the vehicle may also be obtained from an on-board navigational system. In one example, the controller on-board the vehicle may include a navigation system (e.g., global positioning system, GPS) via which a location of the vehicle (e.g., GPS co-ordinates of the vehicle) may be retrieved. In another example, the location of the vehicle may be retrieved form an external network communicatively coupled to the vehicle.

At 504, the routine includes determining if the engine is at least partially being fueled with hydrogen. In one example, a mixture of hydrogen and diesel may be injected to each cylinder. In another example, hydrogen may be injected to the engine cylinders as the only fuel. If it is determined that engine operation is carried out without hydrogen being injected, at 505, current engine operation may be continued, and in response to a vehicle stop, the engine may be shut-down without purging fuel lines of hydrogen.

If it is determined that the engine is at least partially fueled with hydrogen, at 506, the routine includes determining if the conditions are met for fuel lines (such as first fuel line portion 334 and the second fuel line portion 338 in FIG. 3) of the engine to be purged of hydrogen. The conditions for purging the fuel lines may include the vehicle being stopped at a maintenance station. The engine may be shut-down and the vehicle may come to a full stop, and maintenance work may be carried out on one or more components of the vehicle. As an example, the controller may determine the vehicle stop to be at a maintenance station based on the geographical location of the vehicle. Further, a maintenance stop may be indicated by a vehicle operator or a technician via a HMI. The conditions for purging the fuel lines may further include a higher than threshold duration elapsing since the last purge of the fuel lines. The conditions for purging the fuel lines may also include a concentration of hydrogen in the fuel lines to be higher than a first threshold concentration, the first threshold concentration calibrated based on flammability of hydrogen and the geometry of the fuel lines.

If it is determined that conditions are not met for purging the fuel lines, at 505, current vehicle operation may be continued without initiation of a purge routine. If it is determined that conditions are met for purging the fuel lines, at 508, supply of hydrogen from the fuel reservoir to the fuel modification unit may be suspended, such as by actuating each of the first valve (such as valve 332 in FIG. 3) housed in the first fuel line portion connecting the fuel reservoir to the fuel modification unit and the second fuel valve (such as valve 336 in FIG. 3) to a closed position. Alternatively, a tank containing a purge fluid may be attached to the fuel lines via hoses after the fuel lines have been vented of hydrogen.

At 510, a purge fluid may be routed through the fuel lines to purge the hydrogen from the fuel lines. The purge fluid may be contained in a tank (such as tank 354 in FIG. 3) present in the vehicle or attached to the vehicle (during the maintenance stop) and in response to the conditions for purging being met, a purge valve (such as valve 356 in FIG. 3) may be actuated to an open position to route the purge fluid through the fuel lines via a purge line (such as purge line 356 in FIG. 3). The purge fluid may be one of an inert gas (such as helium, argon), nitrogen, exhaust gas, oxygen, etc. stored at a higher than atmospheric pressure. As the pressurized fluid flows through the fuel lines, the lines may be purged of hydrogen.

At 512, the hydrogen (diluted with the purge fluid) from the fuel lines may be routed to the exhaust stack where it may be captured in a tank or released to the atmosphere. In one example, the hydrogen may be routed to the engine where it may be combusted. The purging of the fuel lines may be continued until hydrogen concentration reduces to a second threshold concentration, the second threshold concentration lower than the first threshold concentration. At the second threshold concentration, no significant amount of hydrogen may remain in the fuel lines.

In this way, during a first condition, a second fuel line portion joining the vaporizer unit to the engine may be vented until the second fuel line portion is depressurized, and during a second condition, each of the first fuel line portion and the second fuel line portion may be vented. The first condition may include a long engine shut-down request with no subsequent engine start anticipated within the threshold duration. The second condition may include a short engine shut-down request with an engine start anticipated within a threshold duration of the shut-down request. Further, the second condition may also include suspension of injection of hydrogen to engine cylinders as fuel, and continuation of fueling using another fuel.

The technical effect of venting the fuel lines to remove hydrogen following an engine shut-down request is that hydrogen may not come into contact with engine components, which may retain heating for a duration after the engine shut-down request. By continuing to spin the engine and suspending fuel injection, the hydrogen remaining in the fuel lines may be drawn out, diluted and/or combusted, and then released to atmosphere. By establishing a bypass line from the fuel line to the exhaust stack, the hydrogen may be directly venting to the exhaust stack while not coming in contact with hot exhaust turbine.

As used herein, an element or step recited in the singular and proceeded with the word “a” or “an” do not exclude plural of said elements or steps, unless such exclusion is indicated. Furthermore, references to “one embodiment” of the invention do not exclude the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

As used herein, the term “approximately” is means plus or minus five percent of a given value or range unless otherwise indicated.

An example method for a vehicle comprises: selectively venting, purging, or both venting and purging at one or more portions of a fuel line to remove hydrogen from the fuel line in response to an engine shut-down request. In any of the preceding examples, additionally or optionally, the fuel line includes one or both of a first fuel line portion joining a fuel reservoir housing hydrogen to a vaporizer unit and a second fuel line portion joining the vaporizer unit to the engine. In any or all of the preceding examples, additionally or optionally, the engine shut-down request is one of a short engine shut-down request with a subsequent engine start anticipated within a threshold duration of the engine shut-down request, a long engine shut-down request with no subsequent engine start anticipated within the threshold duration, and a maintenance stop with the vehicle being stopped at a maintenance station. In any or all of the preceding examples, additionally or optionally, venting the fuel lines includes, in response to the short engine shut-down request, suspending flow of hydrogen from the fuel reservoir to the vaporizer unit, and venting the second fuel line portion without venting the first fuel line portion. In any or all of the preceding examples, additionally or optionally, venting the second fuel line portion includes rotating the engine one or more times with throttle and/or injectors open to draw in hydrogen from the second fuel line portion to the engine, combusting the hydrogen, and then routing combusted hydrogen to an exhaust stack. In any or all of the preceding examples, additionally or optionally, the rotating the engine one or more times is using angular momentum during engine coast down or via operation of a starter motor powered from an on-board battery, the method further comprising, during the rotating the engine one or more times, operating an intake compressor to route compressed air through the engine to dilute the hydrogen flowing through the engine. In any or all of the preceding examples, additionally or optionally, venting the fuel line includes, in response to the long engine shut-down request, suspending flow of hydrogen from the fuel reservoir to the vaporizer unit, and venting both the first fuel line portion and the second fuel line portion. In any or all of the preceding examples, additionally or optionally, in response to the long engine shut-down request, venting the each of the first fuel line portion and the second fuel line portion, the venting the second fuel line portion further including, routing hydrogen from the second fuel line portion directly to the exhaust stack downstream of an exhaust turbine via a bypass passage, bypassing the engine. In any or all of the preceding examples, additionally or optionally, the bypass passage is coupled to the second fuel line portion via a bypass valve, the bypass valve positioned between the vaporizer unit and the engine. Any or all of the preceding examples, additionally or optionally, further comprising, in response to the long engine shut-down request, venting the second fuel line portion until a pressure in the second fuel line portion reduces to atmospheric pressure, and then actuating the bypass valve to a closed position. Any or all of the preceding examples, additionally or optionally, further comprising, in response to the maintenance stop, purging the first fuel line portion and the second fuel line portion by flowing a pressurized purging fluid via each of the first fuel line portion and the second fuel line portion, the pressurized purging fluid including one of an inert gas, exhaust gas, and oxygen.

Another example method for an engine, comprises: determine an operating condition of the engine as being at least one of a first condition or a second condition, venting each of a first fuel line portion coupling a fuel reservoir to a vaporizer unit and a second fuel line portion joining the vaporizer unit to the engine until both fuel lines are depressurized during the first condition, and venting and depressurizing the second fuel line portion during the second condition. In any of the preceding examples, additionally or optionally, the fuel reservoir contains hydrogen and the first fuel line portion and the second fuel line portion are vented of hydrogen gas. In any or all of the preceding examples, additionally or optionally, the first condition includes a long engine shut-down request with no subsequent engine start anticipated within a threshold duration, and wherein the second condition includes a short engine shut-down request with an engine start anticipated within the threshold duration of the shut-down request. In any or all of the preceding examples, additionally or optionally, the second condition further includes, suspension of injection of hydrogen to engine cylinders as fuel, and continuation of fueling using another fuel, the engine being a multi-fuel engine. In any or all of the preceding examples, additionally or optionally, venting each of the first fuel line portion and the second fuel line portion includes, suspending flow of hydrogen from the fuel reservoir to the vaporizer unit, and actuating a valve housed in the second fuel line portion to an open position to route hydrogen from the first fuel line portion to an exhaust stack via a bypass line. In any or all of the preceding examples, additionally or optionally, the venting each of the first fuel line portion and the fuel second line includes rotating the engine one or more times, via a starter motor, while flowing air through the engine, and then routing hydrogen diluted with air from the engine to the exhaust stack. In any or all of the preceding examples, additionally or optionally, the venting each of the first fuel line portion and the fuel second line includes rotating the engine one or more times, injecting hydrogen to engine cylinders, combusting the hydrogen in the engine cylinders, and then routing the exhaust to the exhaust stack. In any or all of the preceding examples, additionally or optionally, during the first condition, the venting of each of the first fuel line portion and the second fuel line portion is carried out for a threshold number of engine rotations, and during the second condition, the venting of the second fuel line portion is continued until the pressure in the second fuel line portion decreases to the atmospheric pressure.

Yet another example for a dual-fuel engine in a vehicle, comprises: a controller storing instructions in non-transitory memory that, when executed, cause the controller to: in response to a request to suspend fueling engine cylinders with hydrogen, rotate the engine one or more times, unfueled, to route hydrogen from a fuel line to an exhaust stack. In any of the preceding examples, additionally or optionally, the fuel line connects a gas reservoir containing hydrogen to the engine via a vaporizer unit, and wherein the engine is rotated for a threshold number of rotations while flowing ambient air through the engine.

In one embodiment, the control system, or controller, may have a local data collection system deployed and may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. The tasks may be machine learning problems such as classification, regression, clustering, density estimation, dimensionality reduction, anomaly detection, and the like. In examples, machine learning may include a plurality of mathematical and statistical techniques. The machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components are restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and control, behavior analytics, and the like.

In one embodiment, the control system, or controller, may have a local data collection system deployed and may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. The tasks may be machine learning problems such as classification, regression, clustering, density estimation, dimensionality reduction, anomaly detection, and the like. In examples, machine learning may include a plurality of mathematical and statistical techniques. The machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components are restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and control, behavior analytics, and the like.

In one embodiment, the controller may include a policy engine that may apply one or more policies. These policies may be based at least in part on characteristics of a given item of equipment or environment. With respect to control policies, a neural network can receive input of a number of environmental and task-related parameters. The neural network can be trained to generate an output based on these inputs, with the output representing an action or sequence of actions that the engine system should take. This may be useful for balancing competing constraints on the engine. During operation of one embodiment, a determination can occur by processing the inputs through the parameters of the neural network to generate a value at the output node designating that action as the desired action. This action may translate into a signal that causes the engine to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes. These may be weighed relative to each other.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method for an engine in a vehicle, comprising:
selectively venting, purging, or both venting and purging at one or more portions of a fuel line to remove hydrogen from the fuel line in response to an engine shut-down request, wherein the engine is adapted for combustion of more than one type of fuel and the more than one type of fuel comprises hydrogen, each of the more than one type of fuel comprises a source or reservoir, venting comprises suspending flow of hydrogen from the source or reservoir of hydrogen and removing hydrogen from at least a portion of the fuel line joining the engine and a vaporizer unit so as to reduce contact of hydrogen with components of the engine, and purging comprises routing a purge fluid so as to reduce a hydrogen concentration in at least a portion of the fuel line joining the source or reservoir of hydrogen and the vaporizer unit.

2. The method of claim 1, wherein the fuel line includes a first fuel line portion joining a fuel reservoir housing hydrogen to the vaporizer unit and a second fuel line portion joining the vaporizer unit to the engine.

3. The method of claim 2, wherein the engine shut-down request is one of a short engine shut-down request with a subsequent engine start anticipated within a threshold duration of the engine shut-down request, a long engine shut-down request with no subsequent engine start anticipated within the threshold duration, and a maintenance stop with the vehicle being stopped at a maintenance station.

4. The method of claim 3, wherein venting the fuel lines includes, in response to the short engine shut-down request, suspending flow of hydrogen from the fuel reservoir to the vaporizer unit, and venting the second fuel line portion without venting the first fuel line portion.

5. The method of claim 4, wherein venting the second fuel line portion includes rotating the engine one or more times with throttle and/or injectors open to draw in hydrogen from the second fuel line portion to the engine, combusting the hydrogen, and then routing combusted hydrogen to an exhaust stack.

6. The method of claim 5, wherein the rotating the engine one or more times is using angular momentum during engine coast down or via operation of a starter motor powered from an on-board battery, the method further comprising, during the rotating the engine one or more times, operating an intake compressor to route compressed air through the engine to dilute the hydrogen flowing through the engine.

7. The method of claim 5, wherein venting the fuel line includes, in response to the long engine shut-down request, suspending flow of hydrogen from the fuel reservoir to the vaporizer unit, and venting both the first fuel line portion and the second fuel line portion.

8. The method of claim 7, wherein in response to the long engine shut-down request, venting the each of the first fuel line portion and the second fuel line portion, the venting the second fuel line portion further including, routing hydrogen from the second fuel line portion directly to the exhaust stack downstream of an exhaust turbine via a bypass passage, bypassing the engine.

9. The method of claim 8, wherein the bypass passage is coupled to the second fuel line portion via a bypass valve, the bypass valve positioned between the vaporizer unit and the engine.

10. The method of claim 9, further comprising, in response to the long engine shut-down request, venting the second fuel line portion until a pressure in the second fuel line portion reduces to atmospheric pressure, and then actuating the bypass valve to a closed position.

11. The method of claim 3, in response to the maintenance stop, purging the first fuel line portion and the second fuel line portion by flowing a pressurized purging fluid via each of the first fuel line portion and the second fuel line portion, the pressurized purging fluid including one of an inert gas, exhaust gas, and oxygen.

12. A method for an engine comprising:
determine an operating condition of the engine as being at least one of a first condition or a second condition;
venting each of a first fuel line portion coupling a fuel reservoir to a vaporizer unit and a second fuel line portion joining the vaporizer unit to the engine until both fuel lines are depressurized during the first condition, and
venting and depressurizing the second fuel line portion during the second condition, wherein the engine is adapted for combustion of more than one type of fuel and the more than one type of fuel comprises hydrogen, each of the more than one type of fuel comprises a source or reservoir, and venting comprises suspending flow of hydrogen from the source or reservoir of hydrogen and removing hydrogen from at least the second fuel line joining the engine and the vaporizer unit so as to reduce contact of hydrogen with components of the engine.

13. The method of claim 12, wherein the fuel reservoir contains hydrogen and the first fuel line portion and the second fuel line portion are vented of hydrogen gas.

14. The method of claim 12, wherein the first condition includes a long engine shut-down request with no subsequent engine start anticipated within a threshold duration, and wherein the second condition includes a short engine shut-down request with an engine start anticipated within the threshold duration of the shut-down request.

15. The method of claim 12, wherein the second condition further includes, suspension of injection of hydrogen to engine cylinders as fuel, and continuation of fueling using another fuel, the engine being a multi-fuel engine.

16. The method of claim 12, wherein venting each of the first fuel line portion and the second fuel line portion includes, suspending flow of hydrogen from the fuel reservoir to the vaporizer unit, and actuating a valve housed in the second fuel line portion to an open position to route hydrogen from the first fuel line portion to an exhaust stack via a bypass line.

17. The method of claim 16, wherein the venting each of the first fuel line portion and the fuel second line includes rotating the engine one or more times, injecting hydrogen to engine cylinders, combusting the hydrogen in the engine cylinders, and then routing the exhaust to the exhaust stack.

18. The method of claim 12, wherein during the first condition, the venting of each of the first fuel line portion and the second fuel line portion is carried out for a threshold number of engine rotations, and during the second condition, the venting of the second fuel line portion is continued until the pressure in the second fuel line portion decreases to the atmospheric pressure.

19. A system for a dual-fuel engine in a vehicle, comprising:
a controller storing instructions in non-transitory memory that, when executed, cause the controller to:
in response to a request to suspend fueling engine cylinders with hydrogen,
rotate the engine one or more times, unfueled, to route hydrogen from a fuel line to an exhaust stack, wherein the engine is adapted for combustion of more than one type of fuel and the more than one type of fuel comprises hydrogen, each of the more than one type of fuel comprises a source or reservoir, rotating the engine one or more times, unfueled, to route hydrogen from the fuel line to the exhaust stack comprises suspending flow of hydrogen from the source or reservoir of hydrogen and removing hydrogen from at least a portion of the fuel line joining the engine and a vaporizer unit so as to reduce contact of hydrogen with components of the engine.

20. The system of claim 19, wherein the fuel line connects a gas reservoir containing hydrogen to the engine via the vaporizer unit, and wherein the engine is rotated for a threshold number of rotations while flowing ambient air through the engine.
